(19) United States
(12) Patent Application Publication
(10) Pub. No.: US 2024/0051848 A1
(43) Pub. Date: Feb. 15, 2024

(54) Method for Purifying Contaminated Water

(71) Applicant: MANN+HUMMEL Life Sciences & Environment Holding Singapore Pte. Ltd., Singapore (SG)

(72) Inventors: Maximilian WERNER, Griesheim (DE); Dominik SCHREIER, Bad Kreuznach (DE); Martin HETSCHEL, Bochum (DE)

(21) Appl. No.: 18/496,128

(22) Filed: Oct. 27, 2023

Related U.S. Application Data
(63) Continuation of application No. PCT/IB2022/053857, filed on Apr. 26, 2022.

(30) Foreign Application Priority Data
Apr. 27, 2021 (DE) 102021110765.2

(51) Int. Cl. C02F 1/28; C02F 1/00; C02F 3/02

(52) U.S. Cl. CPC C02F 1/281; C02F 1/001; C02F 3/02; C02F 2001/007; C02F 2203/006; C02F 2301/043

(57) ABSTRACT

The present invention discloses a purification method for purifying contaminated water, comprising at least one biological purification path as well as a filtration purification path, wherein the filtration purification path is operated at least partially in parallel to the biological purification path with a partial flow which is removed from the biological purification path. The purification method according to the invention can be used as, preferably last, stage of a purification process in a wastewater treatment plant prior to introducing the purified water into a river, lake or the ocean.

### TECHNICAL FIELD

The present invention concerns a method for purifying contaminated water which comprises a filtration stage in the partial flow and at least partially parallel to a conventional biological purification stage. The method finds application for purifying contaminated water, for example, precipitation water or surface water, e.g., as add-on to biological purification stages, parallel to a sedimentation stage.

### PRIOR ART

Contaminated water that is to be returned to the water cycle must be purified increasingly more strongly prior to the return. On the one hand, the regulatory requirements on water that is to be returned into rivers, lakes or the ocean increase. On the other hand, the technical requirements increase also, e.g., due to contaminations such as bacteria, including also multi-resistant germs, increasing problems due to plastic materials, inter alia also microplastics, but also mineral contaminations or trace substances such as e.g., phosphate, as they can be generated from industrial or agricultural inputs.

An overview of the prior art is provided in “Einsatz von Membranverfahren zur Wasser-/Abwasserbehandlung Übersicht der Hersteller von Membranmodulen und-anlagen” (translation: “Use of membrane methods for water/wastewater treatment overview of manufacturers of membrane modules and facilities”), Kompetenzzentrum Mikroschadstoffe, N R W, 2018. Disclosed in this context are the elimination of micro pollutants by means of oxidative, adsorptive, and physical methods. Adsorptive methods can be performed with pulverized activated carbon or granulated activated carbon. When using a membrane bioreactor, the activated carbon can be added, e.g., to the aeration tank. The membrane is used for separation of the activated sludge of biologically purified wastewater so that a secondary clarification tank can be dispensed with. Due to the membrane filtration, the activated carbon is retained also.

The requirements on the wastewater purification have continuously increased in recent years and will be further tightened also in the future. More complex technologies are being used increasingly in this context. According to the current state of the art, a method technology that achieves, in combination with other applications, the highest purification effect in relation to various contaminants is the membrane technology.

Many (communal) wastewater treatment plants operate still exclusively according to conventional plant technology, i.e., they exclusively rely on a biological purification path. Furthermore, existing plants, in particular in metropolitan areas, increasingly reach their capacity limits which requires upgrading. Upgrading of the plants is complex and expensive and is therefore shied away from.

### SUMMARY OF THE INVENTION

In view of this background, the present invention has the object to provide a method for purification of contaminated water with which contaminants can be removed in an economically and technically improved manner from water and existing treatment plants can be enhanced in their capacity at the same time.

The purification method according to the invention for purifying contaminated water comprises at least a biological purification path as well as a filtration purification path, wherein the filtration purification path is operated at least partially in parallel to the biological purification path with a partial flow removed from the biological purification path.

The purification in the filtration purification path comprises the following steps:
supplying a partial flow of the biological purification path to a purification tank;
a membrane module through which the contaminated water is filtered is located in the purification tank;
an adsorption agent is added to the purification tank with the contaminated water in which the membrane module is located, wherein the addition of the adsorption agent is realized at the raw side of the membrane module;
the membrane module is aerated by inflow of air from below, preferably with air bubbles;
wherein the adsorption agent comprises powdered activated carbon, and wherein the steps can be carried out in parallel and/or sequentially.

The purification method according to the invention is used as, preferably last, stage of a purification process in a wastewater treatment plant prior to introducing the purified water into a river, lake or the ocean. The feature that the method according to the invention is used as “last stage” prior to introducing into a river, lake, or the ocean is explicitly optional. In embodiments, it is expressly possible to combine the method with further purification stages downstream, for example, ozonization and/or sand filtration.

The method according to the invention does not completely replace the existing plant technology in the form of a biological purification path by a filtration but combines it in an advantageous manner with the latter. In this way, with minimal investment costs, a capacity expansion for peak loads can be achieved and the quality of the wastewater treatment can be optimized as well.

The installation of a filtration stage and of possible recirculation flows enables an increase of the suspended solids in the upstream biological purification stage and thereby an increase of the plant capacity while simultaneously improving the purification performance. The capacity increase results from the independence from a secondary clarification tank because the sludge-water mixture (so-called excess sludge) which is produced in the biological purification stage is no longer limited by the sedimentation rate of the sludge flakes alone but a (pressure-operated) sludge-water separation is carried out with the aid of the filtration with the membrane module. The increase of the suspended solids leads to free capacities of the aeration tank volumes of the biological purification path. Due to the separation performance of the membrane filtration, the parallel-arranged secondary clarification is also relieved and free capacities are generated in this way.

The addition of the adsorption agent to the purification tank of the filtration purification path is carried out preferably directly, i.e., directly to the purification tank, or indirectly, in particular in certain steps of the biological purification path and/or in the region of a method-based interface between the filtration purification path and the biological purification path.

In this context, aeration can serve primarily for cleaning the membrane module for the filtration cake removal.

The purification method according to the invention that, due to the use of a biological purification path and a filtration purification path, can also be referred to as “membrane hybrid method” can advantageously be used for the technical and constructively simple capacity expansion of existing plants.

The purification method or membrane hybrid method according to the invention enables the flexible adaptation of the membrane operation to the existing requirements by the combination of different method applications. Thus, as a function of the water guidance, the capacity of existing purification stages can be increased or the elimination of micro pollutants can be optimized in that the PAC consumption is reduced. Due to the creation of the different operating modes, there is the possibility of combining upgrading of a plant as a membrane hybrid method with other imminent investment measures (expansion of the secondary clarification or aeration) and utilize economical synergies in this way, whereby the method technology in comparison to competing methods can be realized more economically.

Moreover, the filtration stage can be combined with an ozonization downstream in regard to flow, which, in particular in plants with little space, represents a technically very interesting approach in order to install a further purification stage in a communal wastewater treatment plant and increase the biological performance of the plant at the same time. Here, the possibility is provided of reducing the formation of environmentally damaging oxidation byproducts by means of the upstream membrane. Also, the mobilization of antibiotics-resistant germs by ozonization is significantly reduced with the upstream membrane. In addition, due to the separation of organic compounds that are bound to solids due to the filtration, a reduced ozone addition can be selected and thus an energetic and economical optimization of the ozone-based method can be achieved.

In a further embodiment, the partial flow that is supplied to the filtration purification path can be removed downstream of an aeration tank of the biological purification path. Preferably, the partial flow that is to be supplied to the filtration purification path is furthermore removed upstream of a secondary clarification tank of the biological purification path. In other words, the removal of the partial flow to be supplied to the filtration purification path occurs in regard to flow between the aeration tank and the secondary clarification tank.

The adsorption agent comprises in this context powdered activated carbon, preferably produced from organic material, for example, wood and/or peat. The steps can be realized in parallel and/or sequentially. The method can be used temporarily (depending on the existing hydraulic scenarios) preferably as last stage of the purification process of a wastewater treatment plant prior to introducing the purified water into a river, lake or the ocean. Such a method would, of course, be usable also for the purification of surface water, precipitation water or other contaminated water.

It has been surprisingly found that powdered activated carbon produced on the basis of wood or peat is less abrasive than activated carbon produced, e.g., on a mineral basis.

In the purification method, preferably only one membrane module is flowed through in series in the purification tank by the contaminated water, wherein the contaminated water is supplied to the membrane module from a sedimentation stage, in particular from a secondary clarification tank of the sedimentation stage, without flowing through a second membrane module and is introduced from the purification tank into a river, lake or the ocean without flowing through a further membrane module. Obviously, a plurality of membrane modules can be connected in parallel in the purification tank in order to increase the flow volume.

The nominal grain size of the powdered activated carbon lies preferably between 10 and 150 μm, further preferred between 1 and 50 μm. In this range, the activated carbon in the purification tank can be held suspended by means of the blown-in air, a sufficient purification can be obtained, and the abrasive effect on the membrane will not become too large yet.

Preferably, in the purification method the iodine number of the employed powdered activated carbon is greater than 900 mg/g, further preferred greater than 1,000 mg/g.

The inner surface area of the powdered activated carbon is preferably larger than 800 m²/g, determined according to the BET method.

Prior to adding, the adsorption agent can be mixed, suspended, or dissolved in water, wherein in this context different components of the adsorption agent can be present in suspended, mixed, or dissolved form. In this way, a more precise adding is possible because the adjustment of the concentration of the activated carbon takes place in a separate device outside of the purification tank independent of the purification tank.

Adding the adsorption agent can be carried out in the purification tank at the membrane bioreactor without an upstream contact zone or without contact reactor.

In the purification method, precipitation and/or flocculation agents can be furthermore added. They can be used, e.g., for reduction of the phosphorus contents. In particular, iron or aluminum salts, in particular FeCl₃ or FeAlCl₃, are added in this context.

A microfiltration stage, preferably however an ultrafiltration stage, is used as membrane filtration.

The membrane module can be embodied as a flat membrane module or pocket module but also as a hollow fiber membrane module.

A concrete tank but also optionally a modified standard container can serve as purification tank.

In a further embodiment, a volume flow of purified water returned from a secondary clarification tank can be supplied to the purification tank of the filtration purification path in addition to the contaminated water from the biological purification path.

This has the advantage that, depending on the hydraulic load scenario of the plant as a whole, the entire water volume flow can be passed through the filtration purification path and a higher purification effect is generated in this way. In addition, the return leads to a dilution of the contaminated water from the biological purification path so that the filtration effectiveness of the membrane is increased.

In this case, adding of the adsorption agent to the purification tank of the filtration purification path can be realized in particular in the volume flow of the returned purified water supplied from the secondary clarification tank.

Adding of the adsorption agent to the volume flow returned from the secondary clarification tank can be realized, for example, in an intermediately arranged contact/compensation tank.

This has the further positive effect that a sufficient contact time between the returned volume flow and the adsorption agent is ensured. In addition, an optimal mixing of the adsorption agent into the partial volume flow is ensured.

Alternatively or additionally, the addition of the adsorption agent to the purification tank of the filtration purification path can be realized in an aeration tank of the biological purification path, in particular in a rearward part of the aeration tank, viewed in regard to flow, in particular in a region of the last third of a total length of the aeration tank.

This is technically particularly interesting when little space is available in a plant because no constructive measures are required. In order for the adsorption sites of the powdered active carbon (PAC) not to be occupied by dissolved organic carbon (DOC), it is added in the rearward part of the aeration tank in which many organic substances have already been eliminated. As a supplement to secondary clarification, a further filtration for efficient separation of the PAC is advantageously used in biological stages with activated sludge. Suitable are, for example, cloth filters or sand filters. Since no contact reactor and no sedimentation are required, the investment costs are relatively low and the space requirement is also minimal.

The required specific added quantity of the PAC depends on the selection of the location of adding the powdered activated carbon (PAC). This can vary between 5 and 30 mg PAC/l. For methods with (multiple) recirculation of the PAC, usually an addition between 5 and 10 mg PAC/l is selected. PAC additions up to 30 mg PAC/l are used usually when adding to a separate contact tank. The PAC quantity being added depends in addition also on the selected PAC type.

Finally, according to a further embodiment, a return volume flow from the purification tank of the filtration purification path can be returned into the biological purification path so that in particular the adsorption agent is concentrated in the contaminated water.

This has the further positive effect that an additional contact with the sludge-water mixture is produced and the free “adsorption sites” on the PAC are utilized maximally. A reduction of the added PAC quantity can result due to this further utilization/recycling of the PAC.

### BRIEF DESCRIPTION OF THE DRAWINGS

It is shown in this context in:

FIG. 1 is a schematic of a plant for the purification method in a first embodiment;

FIG. 2 is a schematic of a plant for the purification method in a second embodiment;

FIG. 3 is a schematic of a plant for the purification method in a third embodiment;

FIG. 4 is a schematic of a plant for the purification method in a fourth embodiment.

### EMBODIMENT(S) OF THE INVENTION

For illustrating the invention, the method will be explained with the aid of the embodiments.

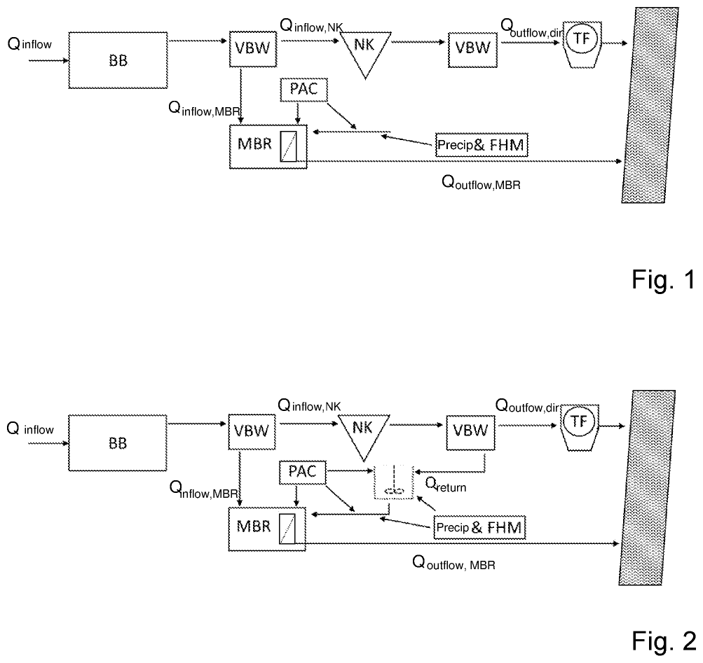

The purification method according to the invention is used, for example, in a (communal) wastewater treatment plant, for the treatment of waste waters which can be contaminated with various substances. A schematic of a plant for performing the method is illustrated in FIG. 1. The plant comprises a “conventional” biological purification path, which, in the illustration of FIG. 1, is illustrated at the top (Q_{inflow} to Q_{outflow,dir}), and a filtration purification path operated with a partial flow of the biological purification path (Q_{inflow,MBR}), comprising a membrane bioreactor (MBR). The flow outlet of the biological purification path (Q_{outflow,dir}) as well as the flow outlet of the filtration purification path (Q_{outflow,MBR}) lead into a surface water, illustrated in FIG. 1 all the way to the right.

Prior to introduction into the surface water as Q_{outflow,dir}, the volume flow flowing through the biological purification path is additionally purified in this context by a cloth filter TF in order to reduce suspended substances that have not been removed in the secondary clarification.

The partial flow Q_{inflow,MBR} supplied to the filtration purification path is branched off the biological purification path downstream of the aeration tank BB but upstream of the secondary clarification tank NK (sedimentation stage). From this branch onward, the filtration purification path is operated at least partially in parallel to the method steps of the biological purification path downstream of the aeration tank BB. The volume flow which is supplied to the further biological purification path is Q_{inflow,NK}.

The supply of the contaminated water to the purification tank of the filtration purification path in which the MBR is immersed, can be realized, for example, by a feed pump or by gravity.

In the filtration purification path, an ultrafiltration membrane technology with powdered activated carbon addition is used as an additional purification stage. The purification of the contaminated water is realized in the filtration purification path with at least one immersed membrane module, in particular flat membrane module, that comprises at least one ultrafiltration membrane.

The addition of the adsorption agent powdered activated carbon (PAC) can be realized directly to the purification tank of the MBR of the filtration purification path. Alternatively or additionally, the addition of the PAC can however also be realized in a volume flow of purified water Qᵣₑₜᵤᵣₙ returned from the secondary clarification tank NK, which is illustrated in FIG. 2.

With the membrane module, suspended matter, dirt particles, viruses, bacteria and inter alia powdered activated carbon are retained. The added powdered activated carbon serves in this context as adsorption medium for removal of contaminants from the contaminated water such as e.g., micro pollutants, in particular micro plastics, dissolved pharmaceutical substances, corrosion protection agents. Due to the addition of precipitation agents and flocculation agents (FHM), dissolved substances such as phosphate are converted into insoluble ones and also removed as solids from the wastewater by the ultrafiltration membrane.

The combination of the method elements ultrafiltration technology with filtration and sedimentation, addition of powdered activated carbon for adsorption, and optionally the addition of precipitation agents and flocculation agents for chemical precipitation constitute in this context the very efficient method according to the invention.

The ultrafiltration membrane of the membrane module immersed in the purification tank, in particular flat membrane module, comprises a membrane with a nominal pore size of 0.01 to <0.1 μm.

The membrane is comprised preferably of polyethersulfone, polysulfone, polyacrylonitrile, polyvinylidene fluoride, polyamide, polyetherimide, cellulose acetate, regenerated cellulose, polyolefins, fluoropolymers, and can be manufactured, for example, in that nonwovens or fabrics are coated with polymer solution and the pores are generated in a subsequent phase inversion step or in that polymer films are stretched in a suitable manner so that the desired pores are produced. Many of these filtration membranes are commercially available, e.g., under the name NADIR® membranes (NADIR Filtration GmbH, Wiesbaden) or Celgard® Flat Sheet Membranes (Celgard Inc., Charlotte, NC, USA).

The purification of the contaminated water is carried out by conveying through the membrane to the so-called permeate side. For this purpose, a vacuum is generated by a pump. The flow performance of the method lies preferably net at 4-31 LMH (liter/m²h).

Below the membrane module, an aeration device is installed through which air generated by a compressor is distributed. For the operation of the method, specific air volume flows, relating to the surface of rise, of 60-115 m³/h (0.125 m³/m²−0239 m³/m²) are used.

The membrane module can be operated in the following filtration cycles: filtration, relaxation, backwashing, relaxation. In the relaxation phase, the membrane unit will be flushed with air without filtration operation.

Cleaning of the membrane unit is realized, depending on the degree of soiling, with sodium hypochlorite, hydrogen peroxide, and/or citric acid. However, other acids, bases or oxidation agents can be used also.

Adding powdered activated carbon with a nominal grain size of 1-50 μm is carried out from a store directly into the purification tank of the MBR. The target concentration of the powdered activated carbon in the purification tank lies between 5-40 mg/l.

The employed powdered activated carbon is produced from wood and/or peat.

The suspended solids contents in the purification tank to be adjusted by the addition of powdered activated carbon lies between 2 and 15 g/l but it can also lie in a range of 1 to 10 g/l. For controlling the total solids in the purification tank, a portion of the activated carbon is discharged discontinuously.

By the application as a membrane-based method for processing biologically treated contaminated water and the addition of powdered activated carbon, the suspended solid contents in the conventional biological purification stage can be increased so that the plant capacity can be expanded and the secondary clarification tank (sedimentation stage) can be relieved due to the separation of the produced sludge.

Moreover, the method can be expanded by adding of precipitation agents and/or flocculation agents (iron or aluminum salts). Addition of the precipitation agents and/or flocculation agents is realized from a store by pumps directly into the purification tank (see FIG. 1) or to the volume flow Qᵣₑₜᵤᵣₙ (see FIG. 2) returned from the secondary clarification tank NK. The added quantity depends on the composition of the medium to be treated and the phosphorus contents contained therein. Due to the chemical precipitation of dissolved phosphorus (orthophosphate) to a solid, insoluble form, this substance can be removed from the medium. Due to the nominal pore width, the ultrafiltration membrane retains particulate solid-bound phosphorus and the chemically precipitated phosphorus. Due to this method component, total phosphorus concentrations of ≤0.2 mg/l are achieved in the permeate, the water purified by the membrane module.

With the method combination, aside from micro pollutants due to the powdered activated carbon addition and phosphorus elimination due to the precipitation agents and flocculation agent addition, bacteria and germs are also separated from the medium.

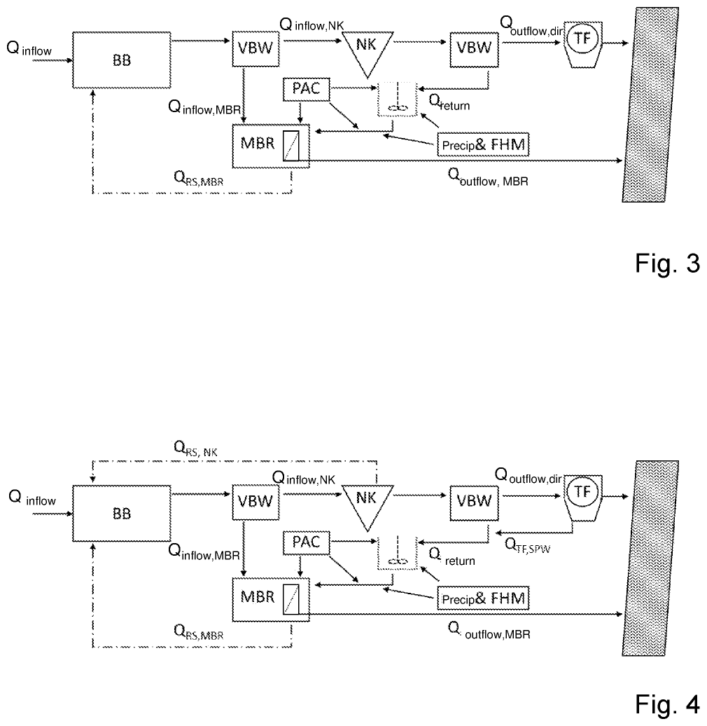

In the further embodiment of FIG. 3, in addition a return volume flow Q_{RS,MBR} from the purification tank of the MBR is returned into the aeration tank BB of the biological purification stage so that the adsorption agent is concentrated in the contaminated water.

In this way, the adsorption agent in the form of the powdered activated carbon PAC is provided with the possibility to remain longer in contact with the sludge-water mixture so that the adsorption capacity of the PAC is used optimally. Due to this optimized utilization of the PAC, the total consumption of PAC can be reduced significantly.

Finally, a further embodiment is illustrated in FIG. 4 which differs from the embodiment of FIG. 3 in that in the biological purification path a volume flow return flow secondary clarification Q_{RS,NK} is provided which is returned from the secondary clarification tank NK into the aeration tank BB. This is advantageous because in this way the biologically activated sludge from the sludge-water mixture Q_{inflow,NK} supplied to the secondary clarification can be separated and remains in the system.

Moreover, a volume flow cloth filter rinsing water Q_{TF,SPW} is removed from the cloth filter TF and is admixed to the volume flow of purified water Qᵣₑₜᵤᵣₙ which is supplied from the secondary clarification tank NK and indirectly supplied to the purification tank of the MBR. The volume flow cloth filter rinsing water Q_{TF,SPW} is in particular removed from the retentate side of the cloth filter.

In this way, it can be ensured that activated carbon particles which are still present in the volume flow Q_{outflow,dir} and have not been separated by the secondary clarification NK (for example, because the grain size is too small) are retained by the cloth filter and remain in the system due to the return. This reduces the consumption of activated carbon even further.

### LIST OF REFERENCE CHARACTERS

Q_{inflow} volume flow/contaminated water inflow
BB aeration tank (biological purification)
VBW distributor structure
Q_{RS,NK} volume flow return secondary clarification (sedimentation stage)
Q_{RS,MBR} volume flow return membrane bioreactor (MBR)
Q_{inflow,MBR} volume flow inflow MBR
Q_{inflow,NK} volume flow inflow secondary clarification
NK secondary clarification (sedimentation stage)
MBR membrane bio reactor
Qᵣₑₜᵤᵣₙ volume flow return
PAC powdered activated carbon
Q_{outflow,dir} direct volume flow to the receiving waters
Q_{TF,SPW} volume flow cloth filter rinsing water
TF cloth filter

1. Purification method for purifying contaminated water, comprising at least one biological purification path as well as a filtration purification path, wherein the filtration purification path is operated at least partially in parallel to the biological purification path with a partial flow removed from the biological purification path,
wherein the purification in the filtration purification path comprises the following steps:
supplying a partial flow of the biological purification path to a purification tank;
a membrane module is located in the purification tank through which the contaminated water is filtered;
an absorption agent is added to the purification tank with the contaminated water in which the membrane module is located, wherein
the addition of the adsorption agent is realized at the raw side of the membrane module; and
the membrane module is aerated by inflow of air from below, preferably with air bubbles;
wherein the adsorption agent comprises powdered activated carbon and wherein the steps can be realized in parallel and/or sequentially; and
wherein the purification method is used as, preferably last, stage of a purification process of a wastewater treatment plant prior to introducing the purified water into a river, lake, or the ocean.

2. Purification method according to claim 1, wherein the partial flow which is supplied to the filtration purification path is removed downstream of an aeration tank of the biological purification path and wherein preferably the partial flow to be supplied to the filtration purification path is removed upstream of a secondary clarification tank of the biological purification path.

3. Purification method according to claim 1, wherein in the purification in the filtration purification path precisely one membrane module is flowed through in series in the purification tank by the contaminated water, wherein the contaminated water is supplied to this membrane module from a sedimentation stage, in particular from a secondary clarification tank of the sedimentation stage, without flowing through a second membrane module and is introduced from the purification tank into a river, lake or the ocean without flowing through a further membrane module.

4. Purification method according to claim 1, wherein the adsorption agent added in the filtration purification path comprises powdered activated carbon, produced from wood and/or peat.

5. Purification method according to claim 1, wherein the nominal grain size of the powdered activated carbon added in the filtration purification path lies between 5 and 150 μm, preferably between 1 and 50 μm.

6. Purification method according to claim 1, wherein the iodine number of the powdered activated carbon used in the filtration purification path is greater than 900 mg/g, preferably greater than 1,000 mg/g.

7. Purification method according to claim 1, wherein the inner surface area of the powdered activated carbon used in the filtration purification path is larger than 800 m²/g, determined according to the BET method.

8. Purification method according to claim 1, wherein the adsorption agent that is used in the filtration purification path is suspended or dissolved in water prior to adding.

9. Purification method according to claim 1, wherein in the filtration purification path precipitation agents and/or flocculation agents are added.

10. Purification method according to claim 9, wherein in the filtration purification path iron or aluminum salts, in particular FeCl₃ or FeAlCl₃, are added.

11. Purification method according to claim 1, wherein the filtration in the filtration purification path through the membrane module is a microfiltration, preferably an ultrafiltration.

12. Purification method according to claim 1, wherein the membrane module used in the filtration purification path is a flat membrane module or a hollow fiber membrane module.

13. Purification method according to claim 1, wherein the purification tank of the filtration purification path comprises a concrete tank or a standard container.

14. Purification method according to claim 1, wherein a volume flow of purified water returned from a secondary clarification tank is supplied to the purification tank of the filtration purification path in addition to the contaminated water from the biological purification path.

15. Purification method according to claim 14, wherein the addition of the adsorption agent to the purification tank of the filtration purification path is carried out in the volume flow of returned purified water supplied from the secondary clarification tank.

16. Purification method according to claim 1, wherein the addition of the adsorption agent to the purification tank of the filtration purification path is realized in an aeration tank of the biological purification path, in particular in a rearward portion of the aeration tank, viewed in flow direction, in particular in a region of the last third of a total length of the aeration tank.

17. Purification method according to claim 1, wherein a return volume flow is returned from the purification tank of the filtration purification path into the biological purification path, whereby in particular the adsorption agent is concentrated in the contaminated water.
